(19) United States
(12) Patent Application Publication
(10) Pub. No.: US 2003/0110291 A1
(43) Pub. Date: Jun. 12, 2003

(54) Method and device for route searching in a bluetooth ad-hoc network

(75) Inventor: Hongyuan Chen, Tokyo (JP)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/020,808

(22) Filed: Dec. 12, 2001

(51) Int. Cl. G06F 15/173

(52) U.S. Cl. 709/244

(57) ABSTRACT

A method for transmitting a route request in an ad-hoc network having master nodes and slave nodes includes transmitting the route request to the master nodes of the network via a unicast transmission and transmitting a reply identifying the route. Each node of the network which receives the request performs a route request algorithm. The algorithm may be implemented in the network layer of the device protocol stack or in the link layer of the device protocol stack.

### BACKGROUND OF THE INVENTION

1. Field of the Invention

The present invention relates to a method and device for efficient route searching in a bluetooth ad-hoc network.

2. Description of the Related Art

An ad-hoc network is a network dynamically formed by nodes or devices (usually wireless mobile nodes) without any network infrastructure or centralized administration. That is, the ad-hoc network is formed by peer-to-peer communication between the devices. New devices are added to the ad-hoc network as required for a communication session or as they come into close proximity to the rest of the network. Likewise, devices are removed from the ad-hoc network at the close of the communication session or as they leave the proximity of the rest of the network. Bluetooth is an example of a technology that uses ad-hoc networking. Bluetooth is a wireless communication technology that uses a frequency-hopping scheme in the unlicensed Industrial-Scientific-Medical (ISM) band at 2.4 GHz. A Bluetooth ad-hoc network includes at least one piconet in which a plurality of Bluetooth nodes or devices are interconnected. One of the nodes of a piconet is designated as a master node and the remainder of the Bluetooth devices in the piconet are slave nodes. All Bluetooth devices in a piconet share the same physical channel defined by the master node parameters (such as the clock and the Bluethooth address). When two piconets are close enough to have overlapping coverage areas, the piconets may be interconnected to form a scatternet. Accordingly, a Bluetooth ad-hoc network may comprise a plurality of piconets. Each piconet in a scatternet is independent and non-synchronized. Time division multiplexing allows one device to participate at appropriate times in multiple piconets.

Known routing algorithms for determining a route to an unknown destination node in ad-hoc networks include the broadcasting of a route search packet to all of the nodes in the network. This route search method is inefficient for Bluetooth ad-hoc networks because the bandwidth of such networks is limited. Moreover, frequent route searches are required in Bluetooth ad-hoc networks because the relatively small coverage area of a Bluetooth node (transceiver) and the mobility of the nodes causes frequent route changes.

### SUMMARY OF THE INVENTION

It is an object of the present invention to provide a route search method for an ad-hoc network that requires less bandwidth than the currently known route searches.

According to an embodiment of the present invention, a route request is transmitted via unicast transmissions to each of the master nodes of a Bluetooth ad-hoc network.

Each communication device (i.e., node) of the ad-hoc network performs a route request transmission algorithm upon receipt of a route request for a route between a source node and a destination node. The communication device may receive the route request from another node in the ad-hoc network or from an upper level protocol within the communication device. If the route request has been previously received, the communication device ignores the route request.

If the communication device is a master node, the algorithm determines whether the destination node of the route request is a member of the piconet of the communication device. A route reply message is transmitted from the communication device to the source node of the route request if the destination node is in the piconet of the communication device. If the destination node is not in the piconet of the communication device, the communication device is added to a Route List maintained in the Route Request packet, and the updated Route Request is forwarded to neighboring master nodes.

If the communication device is not a master node, it is then determined whether the communication node is participating in multiple piconets (i.e., a PMP node). If the communication device is not a PMP node, the Route Request is sent to the master node of the communication node, and it is then determined whether the destination node of the route request is in the piconet of the master node as described above. If the destination node of the route request is not in the piconet of the master node, the communication device is added to the Route List, and the Route Request is forwarded to master nodes of piconets other than the piconet from which the Route Request was received.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a schematic diagram showing the route request path in a scatternet that includes six connected piconets, according to the present invention;

FIG. 2 is a flow diagram depicting the route search method according to an embodiment of the present invention;

FIG. 3 is a block diagram depicting an implementation of the route search in a protocol stack according to the present invention;

FIG. 4 is a schematic diagram depicting the data packet at each level of a protocol stack according to an embodiment of the present invention; and

FIG. 5 is a block diagram depicting a further implementation of the route search in the protocol stack according to the present invention.

### DETAILED DESCRIPTION OF THE PRESENTLY PREFERRED EMBODIMENTS

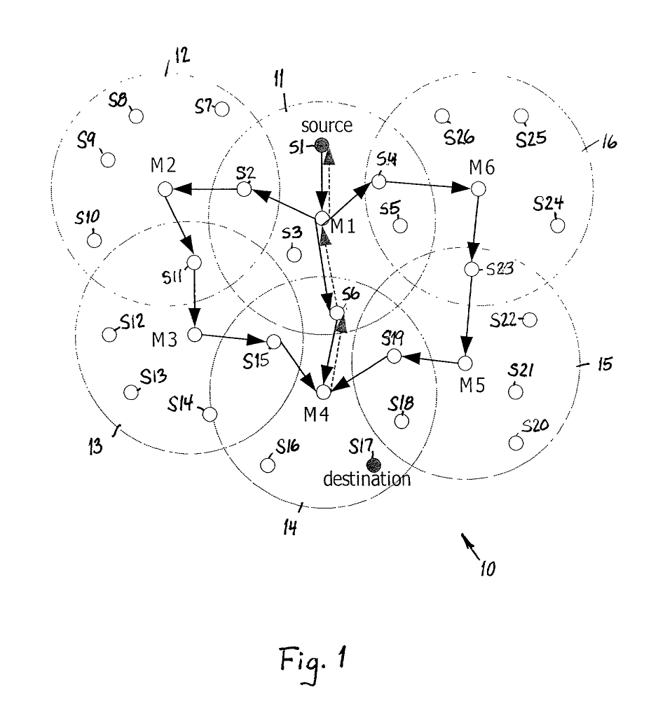

FIG. 1 is a schematic diagram of an ad-hoc bluetooth network, including a scatternet 10 with six interconnected piconets 11-16. Each piconet 11-16 respectively includes a master node M1-M6. Furthermore, slave bluetooth nodes S1-S26 are distributed throughout the scatternet 10. Each piconet 11-16 includes at least one of the slave nodes S1-S26. Although six piconets 11-16 are shown in FIG. 1, the ad-hoc bluetooth network may include as few as only one piconet or multiple piconets, such as the six shown in FIG. 1 or fewer or more than six piconets. Each node M1-M6 and S1-S26 comprises a Bluetooth or Bluetooth-enabled device which is capable of wireless communication via the Bluetooth protocol. The Bluetooth device may comprise any type of mobile device such, for example, as a mobile phone, a laptop or notebook computer, or a Personal Digital Assistant. Furthermore, some Bluetooth devices may be stationary devices which act as beacons. Any of the Bluetooth devices may be connected to another network in addition to the Bluetooth network, thereby acting as a gateway for other Bluetooth devices to the other network.

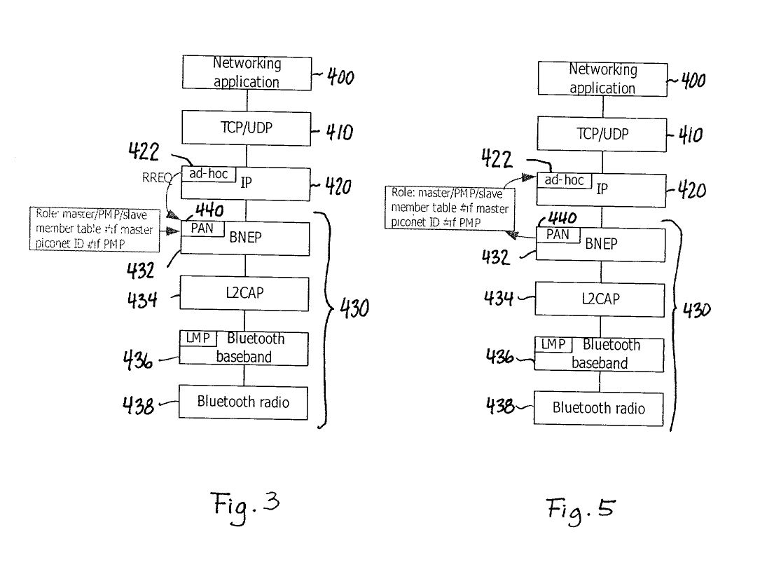

Each node M1-M6 and S1-S26 includes a Personal Area Network (PAN) profile 440 (shown in FIGS. 3 and 5 and described in more detail below) indicating the piconets in which the node is a member. In the master nodes M1-M6, the PAN profile indicates each member of the piconet of which the node is a master, and in the slave nodes S1-S26 the PAN profile identifies its respective master node M1-M6.

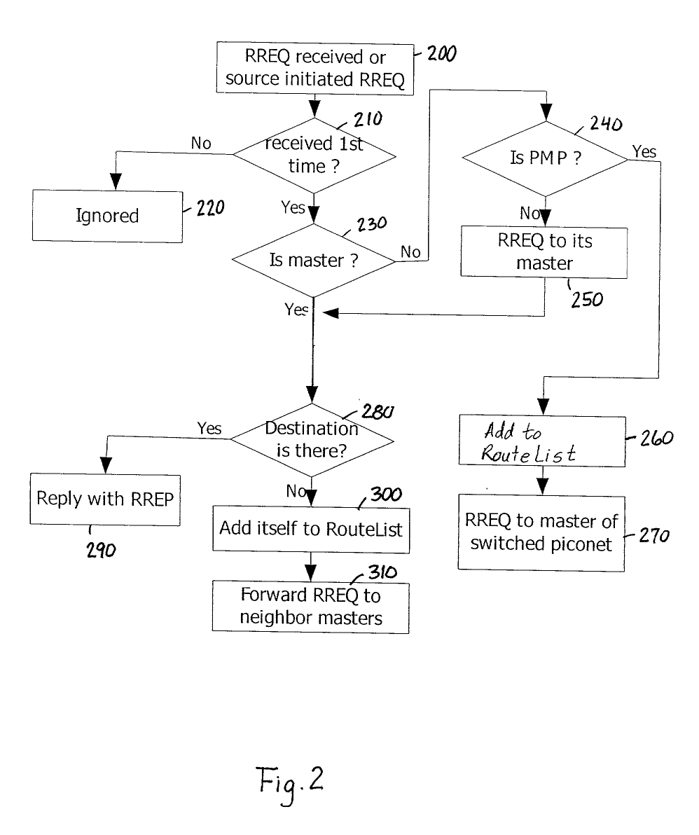

FIG. 2 is a flow diagram depicting the steps performed at a node in the ad-hoc network which receives a route request to perform a route search for a route between a source node and a destination node in the network, according to the present invention. A route request (RREQ) is received at a receiving node in step 200 (the receiving node being any one of the nodes in the ad-hoc network). This step may include receiving the RREQ from another node or receiving the RREQ from an upper layer protocol within the receiving node as will be described below. Step 210 then determines whether the RREQ has been previously received by the receiving node. If it is determined that the RREQ has previously been received by the receiving node, the RREQ is ignored in step 220. These steps prevent the algorithm from being repeated at a node which has already received the RREQ and performed the algorithm, thereby preventing the RREQ from being transmitted backwards along a transmission path that it has already traversed. These steps also prevent each node from being a part of two possible route paths. Accordingly, the processing capacity of each node is not decreased or limited by unnecessary repetition of the route search algorithm.

If it is determined that the RREQ is being received for the first time, then step 230 is performed to determine whether the receiving node is a master node. If it is determined that the receiving node is not a master node, it is then determined whether the receiving node is participating in multiple piconets (i.e., a PMP node), step 240. If the receiving node is determined to be a PMP node, then the receiving node is added to a RouteList of the RREQ packet, step 260, and the RREQ is forwarded to the master nodes of the neighboring piconets, with the exception of the piconet from which the RREQ was received, step 270. The step of forwarding the RREQ to the master nodes of the neighboring piconets is accomplished by using the information in the PAN profile of the receiving node.

If, at step 240, it is determined that the receiving node is not a PMP node, then the RREQ is forwarded to the master node of the piconet in which the receiving node is located using information in the PAN profile of the receiving node, step 250. After forwarding the RREQ to the master node of the receiving node, it is then determined whether the destination node is in the piconet of the master node by querying the PAN profile of the master node, step 280. If the destination node is within the piconet of the master node, a route reply (RREP) is returned to the source node via the reverse of the RouteList attached to the RREQ packet, step 290. If on the other hand it is determined in step 280 that the destination node is not in the piconet of the master node, then the receiving node is added to the RouteList of the RREQ data packet, step 300, and the RREQ is forwarded to the master nodes of the neighboring piconets, step 310. The step of forwarding the RREQ to the master nodes of neighboring piconets may be accomplished by transmitting the RREQ to all PMP nodes in the piconet of the master node based on information in the PAN profile.

If, at step 230, it is determined that the receiving node is a master node, then the member table for the piconet of the receiving node is checked to determine whether the destination node is in the piconet of the receiving node, step 280. If the destination node is within the piconet of the receiving node, a route reply (RREP) is returned to the source node via the reverse of the RouteList attached to the RREQ packet, step 290. If it is determined in step 280 that the destination node is not in the piconet of the receiving node, the receiving node is added to the RouteList of the RREQ data packet, step 300, and the RREQ is forwarded to the master nodes of the neighboring piconets, step 310.

According to the present invention, the RREQ is transmitted via a unicast transmission to each master node and is not transmitted via a broadcast transmission to every node in the network.

Returning to FIG. 1, the arrows depict by way of illustrative example the transmission path of an RREQ from a source node S1 to a destination node S17. The following is a description of how the method of FIG. 2 is performed at each of the source node S1, master node M1, slave node S6, and master node M4 after initiation of an RREQ at source node S1.

Source node S1 is the first receiving node. The algorithm of FIG. 2 starts at node S1 (step 200) by receiving the RREQ from an upper protocol layer in node S1 which has initiated the RREQ. At step 210, it is determined that the RREQ has been received at node S1 for the first time. In step 230, it is further determined that node S1 is not a master node and (at step 240) that it is not a PMP node, and the RREQ is sent to the master node of node S1 in step 250.

Source node S1 is located in piconet 11 and therefore forwards the RREQ to the master node of piconet 11, which is master node M1. The algorithm continues to step 280 at master node M1 where it is determined that the destination node S17 is not present in piconet 11, and master node M1 is added to the RouteList, step 300. The RREQ is then forwarded to the neighboring master nodes in step 310.

In the present example, the master node M1 forwards the RREQ to master nodes M2, M4, and M6 via respective slave nodes S2, S4, and S6. The method of FIG. 2 begins again at each of the slave nodes S2, S4, and S6. At slave node S6, step 200 is performed and the method continues to step 210 with slave node S6 as the receiving node. At step 210, it is determined that the RREQ is being received by node S6 for the first time. The method proceeds to step 230 at which it is determined that slave node S6 is not a master node. The method then proceeds to step 240 to determine that the slave node S6 is a PMP node. Slave node S6 is added to the RouteList in step 260 and the RREQ is sent to master nodes of the neighboring piconets at step 270. In the present example, slave node S6 forwards the RREQ to master node M4.

The algorithm of FIG. 2 is also performed at slave nodes S2 and S4 while slave node S6 performs the algorithm. Since slave nodes S2 and S4 are configured in a manner similar to slave node S6, slave nodes S2 and S4 will perform the same steps of the algorithm as slave node S6. However, at step 270 in slave node S2 the RREQ is forwarded to master node M2, and at step 270 in slave node S4 the RREQ is forwarded to master node M6.

At master node M4, steps 200, 210, 230 and 280 are performed in that order. At step 280, it is determined that the destination node S17 is a member of piconet 14 (i.e., the piconet of master node M4). A route reply RREP is then sent to the source node S1 via slave node S6 and master node M1, step 290. Accordingly, a route has been found between source node S1 and master node M4 of the destination node S17.

The source node S1 will also receive RREPs via the route path formed by nodes M4, S15, M3, S11, M2, S2, and M1 and the path formed by nodes M4, S19, M5, S23, M6, S4, and M1. Accordingly, source node S1 will receive three RREPs from which it must determine how to route communications between source node S1 and destination node S17. The source node may, for example, take into account the speed of the various nodes in the path, the number of nodes in each path, distortion and/or attenuation of each path, and/or any other relevant factors such as the capacity of each path.

FIG. 3 represents a protocol stack of one of the nodes M1-M6 and S1-S26 in which an embodiment of the algorithm of FIG. 2 may be implemented. The stack comprises a networking application layer 400 which handles the details of a particular application, a transport layer 410 which provides a flow of data between two hosts, a network layer 420 which handles the movement of packets around the network (in this case the network is a Bluetooth network), and a link layer 430 (Bluetooth Driver) which handles the interface between the host and the network. Since the network layer handles the movement of packets around the network, the network layer determines how packets are routed from the source node to the destination node. Accordingly, the network layer 420 includes an ad-hoc network block 422 for facilitating formation of the ad-hoc network.

The link layer 430 includes both software and hardware. The software includes a Bluetooth Network Encapsulation Protocol (BNEP) 432 which defines a common packet format to encapsulate the data packet received by the link layer from the network layer 420, a Logical Link Control and Adaptation Protocol (L2CAP) 434 which provides services to upper layer protocols with protocol multiplexing, segmentation and reassembly operation capabilities, and Bluetooth Baseband 436. Bluetooth Baseband 436 may also include hardware and manages the Bluetooth processes. The hardware of the link layer 430 also includes a Bluetooth Radio 438 which implements the air interface, i.e., sends and receives the radio signal. FIG. 3 shows an example in which the link layer comprises a bluetooth driver. However, the link layer may comprise any type of link layer which is capable of forming an ad-hoc network including master nodes and slave nodes.

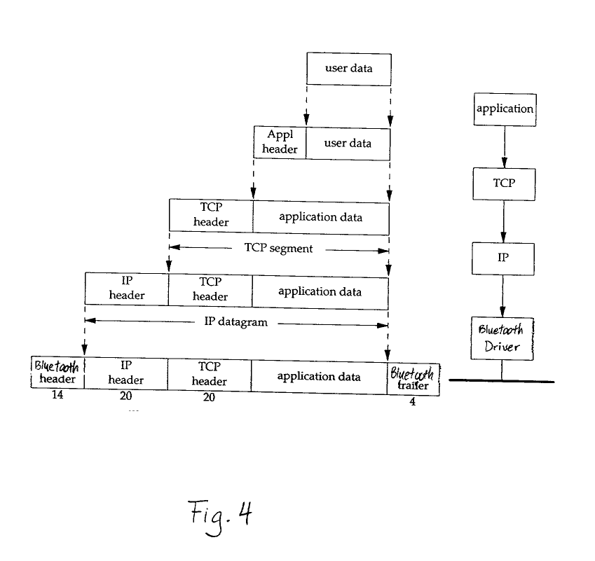

When an application sends data, the data is sent down through each layer of the protocol stack until the data is sent as a stream of bits across the network. Each layer adds a header (some also add a trailer) to the data that it receives. FIG. 4 shows by way of example the encapsulation of data as it travels down the protocol stack. As shown in FIG. 4, the Bluetooth Driver adds a header and trailer to the data packet and the upper layers add only headers to the packets. However, any combination of headers and trailers may be used as matters of design choice according to the present invention.

A Personal Area Network (PAN) is formed by a collection of Bluetooth devices interconnected via one or more piconets to operate together as a logical collective. According to the PAN concept, all of the Bluetooth devices carried by a person are interconnected in a PAN. As the person enters an area with other Bluetooth devices, these other devices may be connected automatically to the PAN via ad-hoc network functionality. The PAN may include one or more piconets. A PAN profile 440 is stored with the BNEP 432 in link layer 430 and includes information regarding the current PAN of which the device is a member. As discussed above, the present invention utilizes the master-slave relationship during performance of the route search. Since the master-slave relationship is defined in the PAN profile 440, the ad-hoc routing algorithm of FIG. 2 may be installed with the PAN profile 440 in BNEP 432. In this embodiment, only the PAN profile 440 needs to be modified to implement the present invention. When the BNEP 432 receives a RREQ from the ad-hoc network block 422 of the network layer 420, the PAN profile 440 will perform steps according to the ad-hoc routing algorithm. In this embodiment, any upper layer ad-hoc networking algorithm is supported.

In a further embodiment shown in FIG. 5, the ad-hoc routing algorithm of FIG. 2 is implemented in the ad-hoc network block 422 of network layer 420. In this embodiment, the information in the PAN profile 440 is sent from the BNEP 432 to the network layer 420. When ad-hoc routing is required, routing is performed according to the ad-hoc routing algorithm embedded in the ad-hoc network block 422. This embodiment does not require any change in the lower layers (i.e., link layer) of the protocol stack.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for transmitting a route request for a route between a source node and a destination node in an ad-hoc network and for transmitting a reply identifying the route, the ad-hoc network including a plurality of nodes including at least one master node in at least one piconet, said method comprising:
transmitting the route request from the receiving node in the ad-hoc network to the at least one master node of said at least one piconet via a unicast transmission; and
generating a route reply and sending the route reply to the source node, the route reply identifying the route in the ad-hoc network between the source node and the destination node.

2. The method of claim 1, wherein the route request is received by the receiving node from another node in the at least one piconet.

3. The method of claim 1, wherein the route request is generated within the receiving node.

4. The method of claim 1, further comprising the steps of:
(a) determining, before said step of transmitting, whether the route request has been previously received at the receiving node; and
(b) ignoring the route request if it is determined in said step (a) that the route request has been previously received at the receiving node.

5. The method of claim 4, wherein the route request is received by the receiving node from another node in the at least one piconet.

6. The method of claim 4, wherein the route request is generated within the receiving node.

7. The method of claim 1, further comprising the steps of:
(a) determining, before said step of transmitting, whether the receiving node is a master node; and
(b) determining whether the destination node is in the piconet of the receiving node if it is determined in said step (a) that the receiving node is a master node,
wherein said step of generating a route reply and sending the route reply to the source node is performed if it is determined in said step (b) that the destination node is in the piconet of the node, and said step of transmitting is performed if it is determined in said step (b) that the destination node is not in the piconet of the receiving node.

8. The method of claim 7, further comprising the step of adding the receiving node to a route list of a packet containing the route request before said step of generating a route reply if it is determined in said step (b) that the destination node is in the piconet of the receiving node.

9. The method of claim 1, further comprising the steps of:
(a) determining, before said step of transmitting, whether the receiving node is a master node; and
(b) determining whether the receiving node is participating in multiple piconets if it is determined in said step (a) that the receiving node is not a master node,
wherein said step of transmitting the route request to a master node of the receiving node includes transmitting the route request if it is determined in said step (b) that the receiving node is not participating in multiple piconets.

10. The method of claim 9, further comprising the step:
(c) determining whether the destination node is in the piconet of the master node of the receiving node after said step (b),
wherein said step of generating a route reply and sending the route reply to the source node includes generating and sending the route reply if it is determined in said step (c) that the destination node is in the piconet of the master node of the receiving node, and said step of transmitting the route request includes transmitting the route request if it is determined in said step (c) that the destination node is not in the piconet of the master node of the receiving node.

11. The method of claim 10, wherein the step of transmitting the route request comprises transmitting the route request to master nodes in piconets other than the piconet from which the route request was received if it is determined in said step (b) that the receiving node is participating in multiple piconets.

12. The method of claim 11, further comprising the steps of:
(i) determining, before performing said step (a), whether the route request has been previously received at the receiving node; and
(ii) ignoring the route request if it is determined in said step (i) that the route request has been previously received at the receiving node.

13. The method of claim 1, further comprising the steps of:
(a) determining, before said step of transmitting, whether the receiving node is a master node; and
(b) determining whether the receiving node is participating in multiple piconets if it is determined in said step (a) that the receiving node is not a master node,
wherein said step of transmitting the route request includes transmitting the route request to master nodes in piconets other than the piconet from which the route request was received if it is determined in said step (b) that the receiving node is participating in multiple piconets.

14. A device-readable memory for a communication device, the memory storing device-readable instructions for transmitting a route request in an ad-hoc network and for generating a route reply identifying the route, the route request being one of received at and generated by the communication device for a route between a source node and a destination node in the ad-hoc network, the ad-hoc network including a plurality of nodes including the communication device and at least one master node in at least one piconet, said memory comprising device-readable instructions for transmitting the route request from the communication device in the ad-hoc network to the at least one master node of the at least one piconet via a unicast transmission and for generating a route reply and sending the route reply to the source node, the route reply identifying the route in the ad-hoc network between the source node and the destination node.

15. The memory of claim 14, further comprising device-readable instructions for determining whether the route request has been previously received at the communication device before transmitting the route request and for ignoring the route request if it is determined that the route request has been previously received at the communication device.

16. The memory of claim 14, further comprising device-readable instructions for determining whether the communication device is a master node before transmitting the route request and for determining whether the destination node is in the piconet of the communication device if it is determined that the communication node is a master node, wherein said device-readable instructions for generating a route reply and sending the route reply to the source node include instructions for generating and sending the route reply if it is determined that the destination node is in the piconet of the communication device, and said device-readable instructions for transmitting the route request include instructions for transmitting the route request if it is determined that the destination node is not in the piconet of the communication device.

17. The memory of claim 16, wherein said device-readable instructions for generating a route reply further include device-readable instructions for adding the communication device to a route list of a packet containing the route request before sending the route reply if it is determined that the destination node is in the piconet of the communication device.

18. The memory of claim 14, further comprising device-readable instructions for determining, before transmitting the route request, whether the communication node is a master device and for determining whether the communication device is participating in multiple piconets if it is determined that the communication device is not a master node, wherein said device-readable instructions for transmitting the route request include instructions for transmitting the route request to a master node of the communication device if it is determined that the communication device is not participating in multiple piconets.

19. The memory of claim 18, further comprising device-readable instructions for determining whether the destination node is in the piconet of the master node of the communication device, wherein the device-readable instructions for generating a route reply and sending the route reply to the source node include instructions for generating and sending the route reply if it is determined that the destination node is in the piconet of the master node of the communication device, and said device-readable instructions for transmitting the route request include instructions for transmitting the route request if it is determined that the destination node is not in the piconet of the master node of the communication device.

20. The memory of claim 19, wherein said device-readable instructions for transmitting the route request include instructions for transmitting the route request to master nodes in piconets other than the piconet from which the route request was received if it is determined that the communication device is participating in multiple piconets.

21. The memory of claim 20, further comprising device readable instructions for determining whether the route request has been previously received at the communication device before determining whether the communication device is a master node, and for ignoring the route request if it is determined that the route request has been previously received at the communication device.

22. The memory of claim 14, further comprising device-readable instructions for determining, before transmitting the route request, whether the communication device is a master node and for determining whether the communication device is participating in multiple piconets if it is determined that the communication device is not a master node, wherein said device-readable instructions for transmitting the route request include instructions for transmitting the route request to master nodes in piconets other than the piconet from which the route request was received if it is determined that the communication device is participating in multiple piconets.

23. A wireless communication device for transmitting a route request for a route between a source node and a destination node in an ad-hoc network and for generating a route reply identifying the route, the route request being one of received at and generated by the device, wherein the ad-hoc network includes a plurality of nodes including the device and at least one master node in at least one piconet, said device comprising a transceiver and a memory storing device-executable instructions for transmitting the route request to the at least one master node of the at least one piconet via a unicast transmission and for generating a route reply and sending the route reply to the source node, the route reply identifying the route in the ad-hoc network between the source node and the destination node.

24. The device of claim 23, wherein said transceiver comprises a Bluetooth radio.

25. The device of claim 23, further comprising a protocol stack including a network layer and a link layer, said device-executable instructions comprising a part of said network layer.

26. The device of claim 25 wherein said network layer comprises a network block comprising device-executable instructions for ad-hoc networking, said device-executable instructions for transmitting the route request comprising a part of said device-executable instructions for ad-hoc networking.

27. The device of claim 23, further comprising a protocol stack including a network layer and a link layer, said device executable instructions comprising a part of said link layer.

28. The device of claim 27, wherein said link layer comprises a Bluetooth driver with a personal area network profile, said device-executable instructions comprising a part of said personal area network profile.

29. The device of claim 23, wherein said memory further comprises device-readable instructions for determining whether the route request has been previously received at the communication device before transmitting the route request and for ignoring the route request if it is determined that the route request has been previously received at the communication device.

30. The device of claim 23, wherein said memory further comprises device-readable instructions for determining whether the communication device is a master node before transmitting the route request and for determining whether the destination node is in the piconet of the communication device if it is determined that the communication device is a master node, wherein the device-readable instructions for generating a route reply and sending the route reply to the source node include instructions for generating and sending the route reply if it is determined that the destination node is in the piconet of the communication node, and said device-readable instructions for transmitting the route request include instructions for transmitting the route-request if it is determined that the destination node is not in the piconet of the communication node.

31. The device of claim 30, wherein said device-readable instructions for generating a route reply further include device-readable instructions for adding the communication device to a route list of a packet containing the route request before sending the route reply if it is determined that the destination node is in the piconet of the communication device.

32. The device of claim 23, wherein said memory further comprises device-readable instructions for determining, before transmitting the route request, whether the communication device is a master node and for determining whether the communication device is participating in multiple piconets if it is determined that the communication device is not a master node, wherein said device-readable instructions for transmitting a route request include instructions for transmitting the route request to a master node of the communication device if it is determined that the communication device is not participating in multiple piconets.

33. The device of claim 32, wherein said memory further comprises device-readable instructions for determining whether the destination node is in the piconet of the master node of the communication device, wherein said device-readable instructions for generating a route reply and sending the route reply to the source node include instructions for generating and sending the route reply if it is determined that the destination node is in the piconet of the master node of the communication device, and said device-readable instructions for transmitting the route request include instructions for transmitting the route request if it is determined that the destination node is not in the piconet of the master node of the communication device.

34. The device of claim 33, wherein said device-readable instructions for transmitting the route request include instructions for transmitting the route request to master nodes in piconets other than the piconet from which the route request was received if it is determined that the communication device is participating in multiple piconets.

35. The device of claim 34, wherein said memory further comprises device-readable instructions for determining whether the route request has been previously received at the communication device before determining whether the communication device is a master node, and for ignoring the route request if it is determined that the route request has been previously received at the communication device.

36. The device of claim 23, wherein said memory further comprises device-readable instructions for determining, before transmitting the route request, whether the communication device is a master node and for determining whether the communication device is participating in multiple piconets if it is determined that the communication device is not a master node, said device-readable instructions for transmitting a route request including instructions for transmitting the route request to master nodes in piconets other than the piconet from which the route request was received if it is determined that the communication device is participating in multiple piconets.

37. The device of claim 23, wherein said device comprises a mobile phone.

38. The device of claim 23, wherein said transceiver is operable for communication via a Bluetooth protocol.
